(19) United States
(12) Patent Application Publication
(10) Pub. No.: US 2010/0277313 A1
(43) Pub. Date: Nov. 4, 2010

(54) Light Emitting Device History Log

(76) Inventor: Dimitry Vaysburg, Livermore, CA (US)

Correspondence Address: LAW OFFICE OF GERALD MALISZEWSKI, P.O. BOX 270829, SAN DIEGO, CA, 92198-2829, US

(21) Appl. No.: 12/468,466

(22) Filed: May 19, 2009

Related U.S. Application Data
(63) Continuation-in-part of application No. 12/436,092, filed on May 5, 2009.
Application No. 12/436,092 is a continuation-in-part of application No. 12/436,086, filed on May 5, 2009.
Application No. 12/436,086 is a continuation-in-part of application No. 12/432,625, filed on Apr. 29, 2009.
Application No. 12/432,625 is a continuation-in-part of application No. 12/431,914, filed on Apr. 29, 2009.
Application No. 12/431,914 is a continuation-in-part of application No. 12/432,559, filed on Apr. 29, 2009.

(51) Int. Cl. G08B 21/00

(52) U.S. Cl. 340/540

(57) ABSTRACT

A system and method are provided for presenting an apparatus history using a light emitting device (LED) log. The method provides an apparatus user interface (UI) including a plurality of LEDs and presents an LED log. The LED log emits light as a chronological sequence of a first LED pattern followed by a second LED pattern. Each pattern includes the illumination of at least one LED, and the first pattern is different from the second pattern. In response to the LED log, an apparatus condition is communicated. In one aspect the first pattern includes a first number of illuminated LEDs and a second pattern including a second number of illuminated LEDs, different from the first number. The patterns can also be distinguished by color, on-times, and off-times.

### RELATED APPLICATIONS

This application is a Continuation-in-Part of a pending application entitled, PHOTO MANAGEMENT USING EXPRESSION-BASED. VOICE COMMANDS, invented by Gopi et al., Ser. No. 12/436,092, filed May 5, 2009, attorney docket no. applied_{—}343;

which is a Continuation-in-Part of a pending application entitled, SYSTEM AND METHOD FOR PHOTO-IMAGE LOCAL DISTRIBUTION, invented by Gopi et al., Ser. No. 12/436,086, filed May 5, 2009, attorney docket no. applied_{—}333;

which is a Continuation-in-Part of a pending application entitled, SYSTEM AND METHOD FOR PHOTO-IMAGE UPLINK CONFIRMATION, invented by Vaysburg et al., Ser. No. 12/432,625, filed Apr. 29, 2009, attorney docket no. applied_{—}345;

which is a Continuation-in-Part of a pending application entitled, SYSTEM AND METHOD FOR VIRTUAL KIOSK STORED PHOTO-IMAGE REPRODUCTION, invented by Vaysburg et al., Ser. No. 12/431,914, filed Apr. 29, 2009, attorney docket no. applied_{—}332;

which is a Continuation-in-Part of a pending application entitled, SYSTEM AND METHOD FOR PHOTO-IMAGE DISCOVERY AND STORAGE, invented by Vaysburg et al., Ser. No. 12/432,559, filed Apr. 29, 2009, attorney docket no. applied_{—}330. All these disclosures are incorporated herein by reference.

### BACKGROUND OF THE INVENTION

1. Field of the Invention

This invention generally relates to electronic image processing and, more particularly, to a system and method for photo-image management, transformation, delivery, uplink confirmation, and distribution.

2. Description of the Related Art

Conventional technology permits a user to connect their camera or memory card to a personal computer (PC), open a software application in the PC, and upload images for local storage. Once the images are stored, the user may select images for local printing, organize folders, or create a CD. Further, the images may be uploaded to a network-connected storage site vendor, such as Costco. Once the images are uploaded, the user may select images for printing, and have the printed pictures prepared for pickup or delivery. Otherwise, the user can have the images archived.

Unfortunately, these operations are cumbersome and require extensive human interaction. Further, a minimal amount of technical acumen is required to perform these operations, and if the user is technophobic, the images may remain in the camera until they are lost, erased, or overwritten.

Eye-Fi™ is a wireless memory card that automatically uploads any images on the card, via a WiFi (IEEE 802.11) link, to a user's PC for local storage, or to a network-connected storage site. Unfortunately, the images remain on the memory card until the user comes within range of a WiFi access point (AP). The user cannot upload their images via a public AP unless the card has been previously preconfigured. Such an operation would require the use of a PC and a related software application. Due to the relatively long time it takes to upload a single image, the system is only practical for user who has a personal (home) WiFi AP. Further, while the automatic upload feature is a convenience, the user has lost all ability to edit and organize the images leaving the camera, and it is not necessarily easy to organize the images once they have been uploaded. The user must leave the camera turned on to upload imaged, but neither the camera nor the memory card gives any indication of whether a link is available, the link bandwidth, the number, of files uploaded, or incorrect format issues. As a result, the user must leave the camera on and guess whether the images have been uploaded. Glitches in the upload process often require the camera power to be recycled or WiFi AP to be rebooted. Therefore, user is unaware of which, if any, images have been successfully uploaded until they inventory their storage. Even if the images are successfully uploaded, the camera power may be drained if the user leaves the camera on and hopes for the best.

Conventionally, an end user who wants to print, order prints of their pictures, create albums, or personalize their photos, must use either a PC-driven software tool, or go to a store photo kiosk. The first option requires a working knowledge of PCs and a high-speed Internet connection. Alternately, if a user goes to the store, they must bring their SD card or USB key to select the pictures. This selection process can be lengthy and may require assistance from store personnel.

It would be advantageous if photo-images stored in a network-connected storage site could be managed with a local photo-image discovery device having a simple feedback mechanism to give the user status concerning acquisition, uplink, and downlink operations.

### SUMMARY OF THE INVENTION

A photo discovery system and method are disclosed herein that are capable, of acquiring images from a variety of different sources, such as a digital camera, camcorder, 3G phone, cell phone, or personal computer (PC), and upload them into an Internet-connected storage/processing service. Once stored, the same photo discovery device can be used to print, archive, or otherwise manage the images as a virtual kiosk, without the use of a personal computer (PC). The photo discovery device can also be used to access the photo-images from the storage site and distribute selected photo-images to wireless picture frames. Advantageously, the status of many of the above-mentioned features can be monitored using a light emitting device chronological log.

Accordingly, a method is provided for presenting an apparatus history using a light emitting device (LED) log. The method provides an apparatus user interface (UI) including a plurality of LEDs and presents an LED log. The LED log emits light as a chronological sequence patterns. For example, a first LED pattern may be followed by a second LED pattern. Each pattern includes the illumination of at least one LED, and the first pattern is different from the second pattern. In response to the LED log, an apparatus condition is communicated.

In one aspect the first pattern includes a first number of illuminated LEDs and a second pattern including a second number of illuminated LEDs, different from the first number. The patterns can also be distinguished by color, on-times, and off-times. In another aspect, the apparatus is a photo-image discovery device, and apparatus conditions communicated in response to the LED log include on, shutting down, battery level, photo-capable device discovered, uplink in progress, uplink problems, photo-image acquisition in progress, photo-image acquisition problems, photo-image acquisition complete, memory full, and apparatus conditions in a previous run.

Additional details of the above-described method, and a photo-image discovery device system for presenting a light emitting device (LED) log, are provided below.

### BRIEF DESCRIPTION OF THE DRAWINGS

FIG. 1 is a schematic block diagram of a photo-image discovery device.

FIG. 2 is a diagram depicting a first exemplary image organization transaction.

FIG. 3 is a diagram depicting a second exemplary image organization transaction.

FIGS. 4A and 4B depict two exemplary processes for configuring the photo-image discovery device of FIG. 1.

FIG. 5 is a schematic block diagram of a virtual photo-image reproduction kiosk.

FIG. 6 is a schematic block diagram depicting a system for automatic photo-image uplink confirmation in a photo-image discovery device.

FIG. 7 is a schematic block diagram of a photo-image discovery device with a system for the local distribution of stored photo-images to wireless picture frames.

FIG. 8 is a diagram depicting an exemplary display menu for the selection of wireless picture frames.

FIG. 9 is a diagram depicting a variation in the selection of wireless picture frames.

FIGS. 10A through 10E are diagrams depicting some exemplary motion prompts.

FIG. 11 is a schematic block diagram of a photo-image discovery device with a system for photo management using expression-based voice commands.

FIG. 12 is a photo-image discovery device with a system for presenting a light emitting device (LED) log.

FIG. 13 is a detailed diagram of the LED display of FIG. 12, depicting a first example of an LED log.

FIG. 14 depicts a second example of an LED log.

FIG. 15 depicts a third example of an LED log.

FIG. 16 depicts a fourth example of an LED log.

FIG. 17 depicts a fifth example of an LED log.

FIG. 18 depicts a sixth example of an LED log.

FIG. 19 is a diagram depicting the photo-image discovery device from a functional perspective.

FIG. 20 is a flowchart illustrating a method for presenting an apparatus history using an LED log.

### DETAILED DESCRIPTION

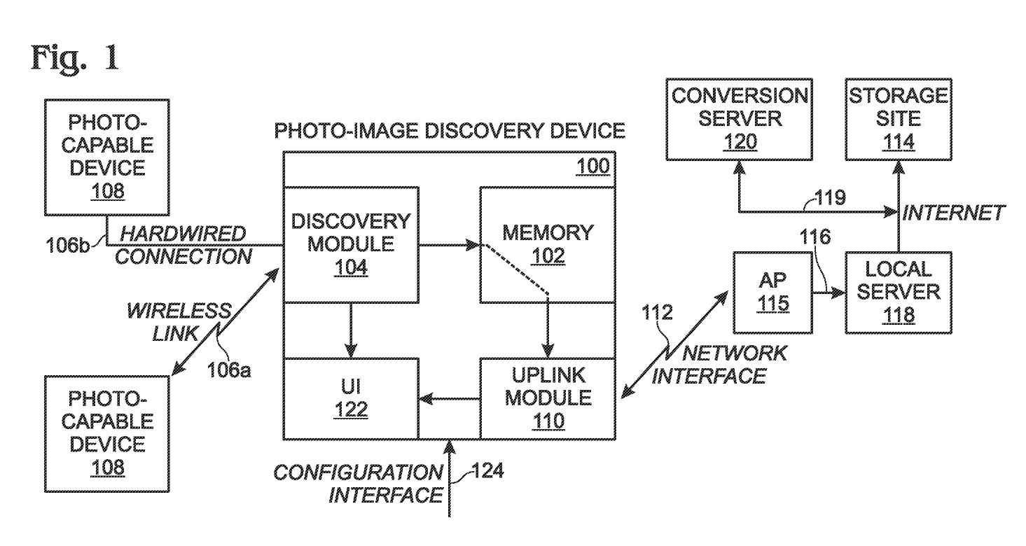

FIG. 1 is a schematic block diagram of a photo-image discovery device. The photo-image discovery device 100 comprises a memory 102 and a discovery module 104 having a scanning interface on line 106 for detecting photo-capable devices. In one aspect, the discovery module scanning interface concurrently scans wireless and hardwired connector interfaces. The wireless interface is represented by reference designator 106a and the hardwire connector interface by reference designator 106b. For simplicity, only a single wireless and single hardwired interface are shown. However, it should be understood that multiple such interfaces may be required for different protocols, frequencies, and connector types.

Some examples of the wireless interface 106a include Bluetooth, wireless USB, and IEEE 802.11 (WiFi) interfaces. However, the device 100 is not limited to just these examples. Some examples of hardwire connector interface 106b include Universal Serial Bus (USB) and SD memory card interfaces. Some examples of photo-image file types include JPEG, GIF, EXIF, native format, BMP, CR2, RAW, and MPEG. Again, the system is not limited to just these exemplary file types and interfaces.

The discovery module 104 determines if detected photo-capable devices 108 have stored electronically formatted photo-images, and if so, acquires the photo-images into the memory 102. If the detected photo-images have been previously acquired into the memory, the photo-images are not reacquired. Some examples of photo-capable devices include a cellular telephone, 3G cell phone, a personal computer (PC), controlled automation device, digital video disk (DVD) device, camera-enabled wireless device, video-enabled wireless device, television, digital video recorder (DVR), secure digital (SD) memory card, digital camera, and game console. Some examples of a controlled automation device include home camera security system and a remotely programmable DVR. In one aspect, the discovery module 104 acquires photo-images from only preconfigured photo-capable devices 108. That is, the discovery module 104 will only acquire photo-images from a limited group of devices with which it has been given permission to act. In this manner, the photo-image discovery device will not “accidentally” acquire images from unauthorized sources. The photo-image discovery device enters photo-capable device configuration commands via a built-in user interface (UI) 122, or via a configuration interface 124, as explained in more detail below.

An uplink module 110 has a network interface on line 112. The uplink module 110 automatically uploads the photo-images in the memory 102 to a network-connected storage site 114. Although only a single storage site is shown for simplicity, it should be understood that the photo-image discovery device is able to communicate with any number of storage sites. The photo-image discovery device may send the same photo-images to more than one storage site. As used herein, a storage site may be a commercial site for printing or archiving photo-images, a site for sharing or publishing photo-images, such as YouTube, or even a local storage site. As another example, a user may be able to monitor their home security system via images sent to a “public” site such as YouTube. As another example, the discovery device may acquire a movie from a device such as a PC, and store the movie in a local memory site. As another example, the discovery device may transfer photo-images acquired from one photo-capable device to a different photo-capable device. In this manner, the photos on one SD card in a first camera may be loaded into the SD card residing in a second camera.

In one aspect, the uplink module 110 uploads photo-images via a WiFi interface to a network-connected server 114. As shown, a WiFi access point (AP) 115 wirelessly receives information from the photo-image discovery device, transfers the information via a landline 116 to a local server 118, which then uses an Internet protocol to transfer the information to storage server 114 via line 119. However, it would be possible to upload photo-images using other nodes or other protocols to reach the storage site.

Typically, the discovery module 104 acquires and stores the photo-images into memory in the first format, and the uplink module 110 uploads the acquired photo-image in the first format. In one aspect, the discovery module uploads photo-images in a first format (e.g., JPEG) and converts the photo-images to a second format (e.g., GIF). Then, the uplink module 110 uploads photo-images in the second format to the storage site 114. Alternately, the discovery module 104 acquires photo-images in a first format and the uplink module 110 uploads the photo-images to a network-connected conversion device 120 for conversion into a second format. In one aspect, the converted photo-images are returned to the photo-discovery device 100 for uplink to the storage site 114. Alternately, the conversion device transfers the converted photo-images to the storage site directly, via line 119.

In a different aspect, the photo-images may be acquired and uploaded in the same file format, but can have image attributes changed such as the resolution, compression ratio, red-eye removal. The attributes changed would be dependent upon the attribute parameters associated with the storage device or destination.

In another aspect, the uplink module 110 has an interface for receiving storage site selection commands and transfers the photo-images to at least one selected storage site. The commands may be entered via a built-in user interface (UI) 122, or communicated via a configuration interface 124, as explained in more detail below. The uplink module 110 may determine a photo-image format associated with the selected storage and direct the discovery module or conversion site to convert acquired photo-images to the format associated with the selected storage device.

In one aspect, the UI 122 receives a signal from the uplink module 110 subsequent to uploading the photo-images to the storage site, indicating that the photo-images have been successfully uploaded. In turn, the UT 122 supplies an indication to the user of a successful upload. Likewise, in the event of a failure to upload the photo-images to the storage site, the uplink module 110 may supply a signal to the UI, and the UI supply a prompt to the user, indicating that the photo-images have not been successfully uploaded.

For example, the UI may be a light emitting diode (LED), or a set of LEDs, where LED groups, LED flash patterns, or LED colors signify different events. In another aspect, the UI 122 may incorporate a visual display, such as a liquid crystal display (LCD). Further, the UI 122 may incorporate buttons, switches, a keypad, or a mouse to accept user commands. In one aspect, the discovery module 104 automatically acquires photo-images from devices. However, in another aspect the discovery module only acquires photo-images in response to a UI prompt. That is, the UI 122 indicates that photo-images are available for acquisition, and the user must affirmatively authorize acquisition using a UI button, switch, or the like.

In a similar manner, if the discovery module 104 fails to acquire the photo-images into the memory, it supplies a signal to the UI indicating that the photo-images have not been successfully acquired. In turn, the UI 122 supplies some kind of indicator to the user. Likewise, if the discovery module 104 successfully acquires the photo-images into the memory, it supplies a signal to the UI 122, and the UI 122 supplies an appropriate indicator to the user.

The discovery module 104 may also organize acquired photo-images into folders using criteria such as user, the photo-image discovery device ID, file types, or the photo-capable device originating the photo-images, to name a few examples. The folders may be established in memory 102. Alternately, instructions may accompany the uplinked photo-images, so that folders are created at the storage site 114, and the photo-images stored in the corresponding folder types.

It is difficult for a user to remember the circumstances associated with each of their photos. This problem is compounded when the user is faced with the daunting task of remembering, sorting, and organizing photos on a camera memory card filled with hundreds of pictures. Conventional processes that simply move the photos from one storage site (i.e. the memory card) to a second storage site (i.e. a PC or network-connected storage site) do not adequately address this problem.

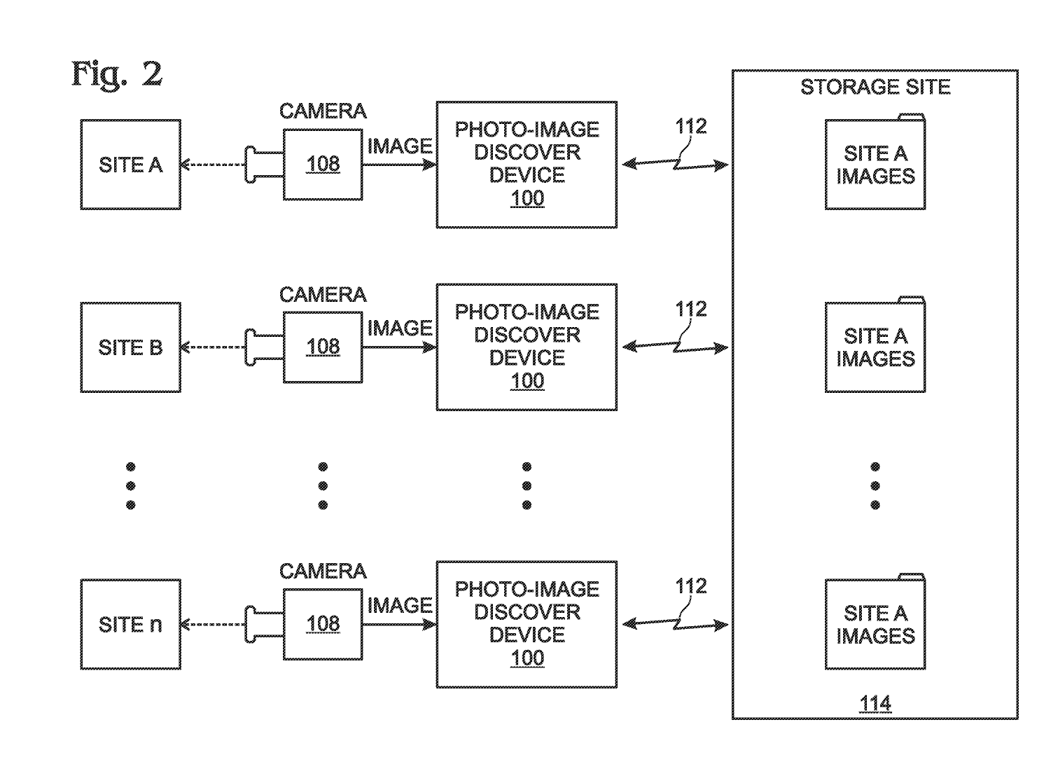

FIG. 2 is a diagram depicting a first exemplary image organization transaction. The photo-image discovery device disclosed herein advantageously acts as an intermediary between images stored on a camera device and storage, giving the user the opportunity to organize images. Some of this organization is performed using the mechanisms already described above. For example, the photo-image discovery device may be preconfigured to separate the images associated with each acquisition/upload operation into a separate folder. If the user is a tourist in Rome, they may choose to manually acquire/upload images after each attraction (sites A through n) they visit. In that manner, the photos associated with each attraction are automatically organized into separate folders at the storage site.

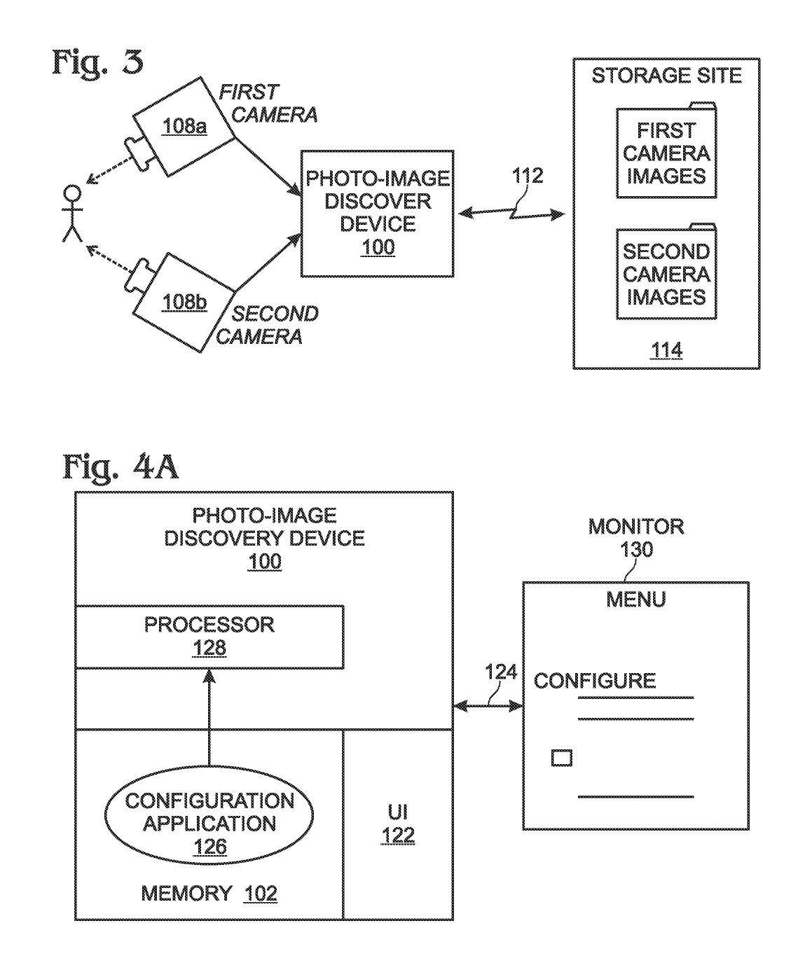

FIG. 3 is a diagram depicting a second exemplary image organization transaction. As another example, the photo-image discovery device may be configured to acquire images from two cameras. If there is a different user associated with each camera, the photo-image discovery device automatically insures that the acquired/uplinked photo-images are being saved in different folders differentiated by user (camera).

More complicated organizational schemes may be pre-configured or implemented on-the-fly if the UI 122 is sophisticated enough. Alternately, if the UI 122 is simple (i.e. a set of LEDs), the configuration interface 124 may be used to enter commands.

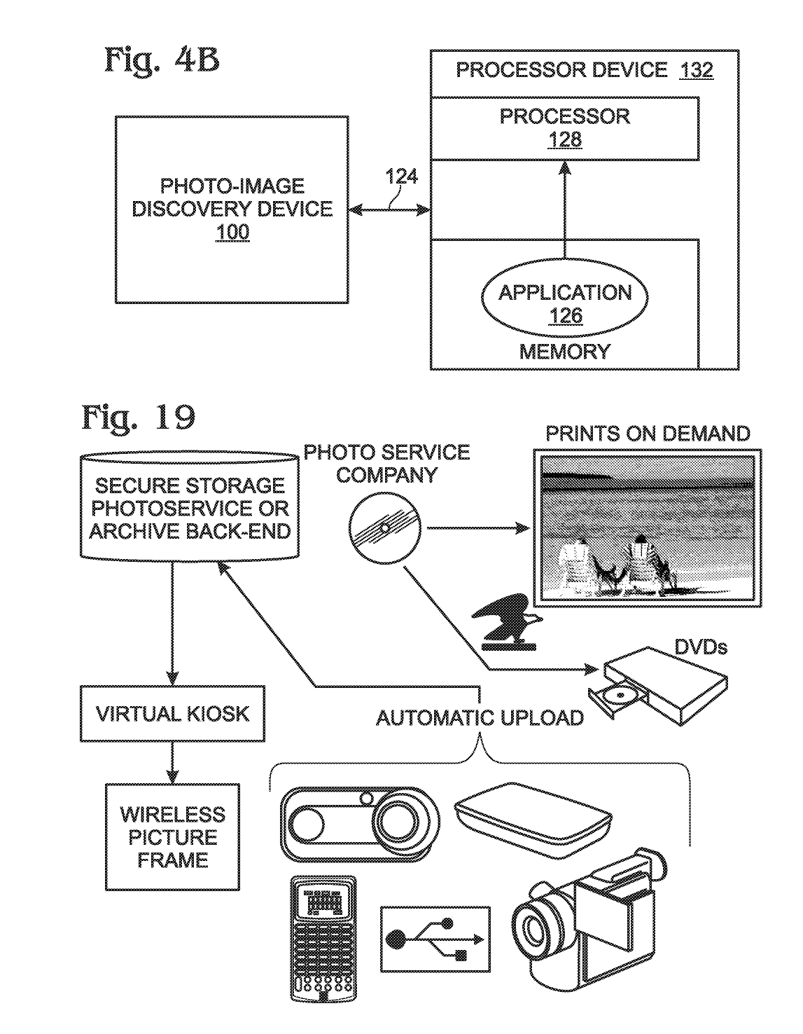

FIGS. 4A and 4B depict two exemplary processes for configuring the photo-image discovery device of FIG. 1. Generally, as shown in FIG. 4A, the configuration interface is wirelessly or hardwire connected to a simple monitor 130, such as a television screen. A configuration software application 126 is stored in memory 102 and enabled as processor instructions. The instructions are executed by processor 128. By executing instructions in the configuration application, the photo-image discovery device is able to generate a menu of instruction prompts and menu options on monitor 130. The user is able to navigate through the menu of prompts and options using the UI 122 (e.g., buttons or keypad). In one aspect, the photo-image discovery device is able to make selections as a wireless point-and-click device.

In another variation (FIG. 4B), the configuration software application 126 resides in a microprocessor device 132 such as a PC or cell phone. Changes and modifications to the photo-image discovery device are made by running the configuration application on the PC. Then, the changes can be loaded into the photo-image discovery device via the configuration interface 124.

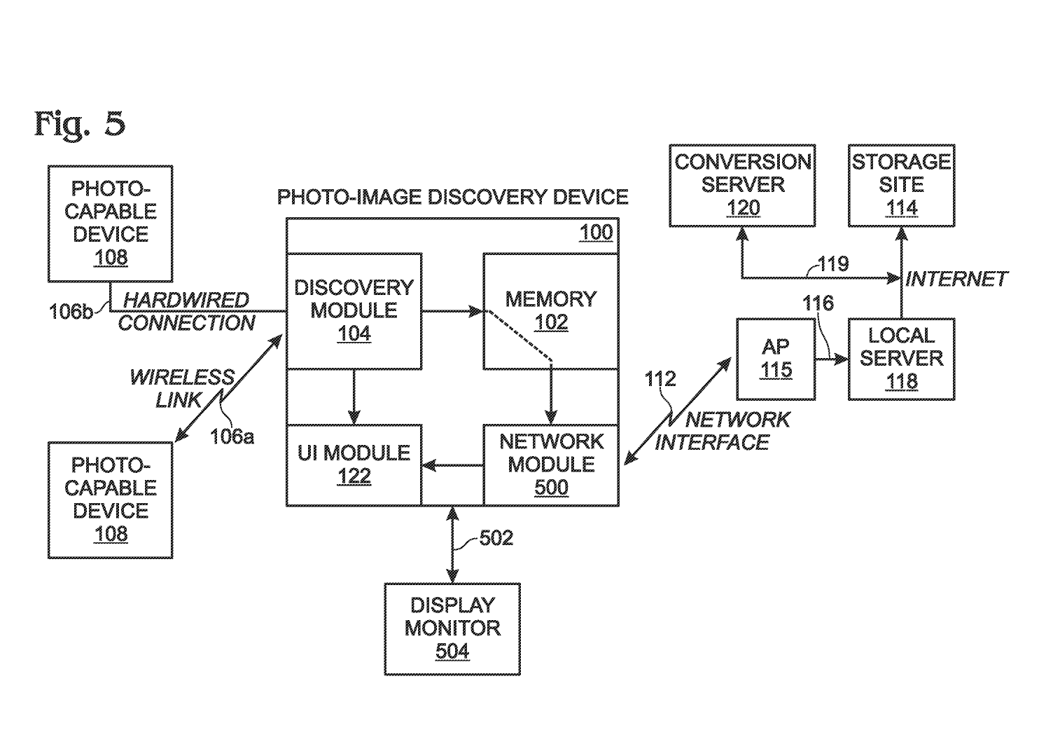

FIG. 5 is a schematic block diagram of a virtual photo-image reproduction kiosk. The virtual kiosk comprises a photo discovery device 100. In one aspect, the photo discovery device may include a few switches and LED indicators, but the photo discovery 100 device has no dedicated display. The photo discovery device 100 includes a network module 500 for automatically uplinking photo-images to a network-connected storage site. This uplink function has been described above in the explanation of the uplink module. However, since the functions of the uplink module are expanded in this aspect, it is referred to as a network module in FIGS. 5-7.

The network module 500 accesses the storage site 114 and downloads selected photo-images. Typically, the network module 500 uplinks and downloads photo-images from the storage site 114 using an IEEE 802.11 (WiFi) link. However, it would be possible to use other wireless formats. In a different aspect, the network module 500 receives a selected photo-image in a first photo-image file format. (e.g. JPEG) and the UI module 122 converts the first photo-image file format to a second file image format (e.g., TIFF). The UI has been described above in FIG. 1 as a relatively simple user interface. However, since the function of the UI is expanded in this aspect, it is referred to as a UI mode in FIGS. 5-7.

The user interface (UI) module 122 has an interface on line 502 for connection to a display monitor 504. The UI module 122 interfaces the photo discovery device to the display monitor 504 using an interface such as USB, high-definition multimedia interface (HDMI), or wireless. The display monitor 504 may be a television, PC, electronic picture frame, gaming platform, or cell phone to name a few examples. Some examples of wireless interfaces include Bluetooth and WiFi. The display monitor 504 is used to visually, and sometimes audibly, present a menu of photo-image user prompt options. The prompt options are used to select stored photo-images in response to the network module 500 accessing the storage site 114.

Generally, the network module 500 sends an inquiry to the storage site 114 requesting an inventory of stored photo-images and receives the inventory results. The UI module 114 presents the inventory results on the display monitor 504. In one aspect, the network module 500 accesses a storage site including a plurality of photo-image folders. The UI module 122 presents the folders on the display monitor 504, and provides prompts for selecting a folder. Some examples of folders are presented in the explanation of FIGS. 2 and 3. However, there are a number of ways of organizing photo-images into folders.

Subsequent to receiving the selected photo-images, the UI module 122 may receive prompts for transforming selected photo-image attributes. Some examples of image transformations include resizing, zooming, placement, cropping, rotation, resolution, compression, color editing, lightness editing, and red-eye removal. However, this is not an exhaustive list of every possible transformation. The UI module 122 can also be used to present a source profile menu for options on the display monitor 504. Some examples of sources include the photo-capable devices originating the photo-images that are uplinked to the storage site, and file formats.

In another aspect, the. UI module 122 can be used to select delivery options for selected photo-images. That is, the network module 500 uplinks photo-images to the storage site 144 and accesses the storage site in response to prompts received by the UI module 122. The UI module also receives prompts for selecting a delivery option from a retailer associated with the first storage site. Then, the network module 500 sends selected delivery options to the storage site. More precisely, the UI module 122 receives input from a user operating the photo discovery device, and sends selection commands in response to the user input. For example, the UI module 122 may receive prompts for selecting a delivery media option such as printed media, DVD, video tape, or SD memory card.

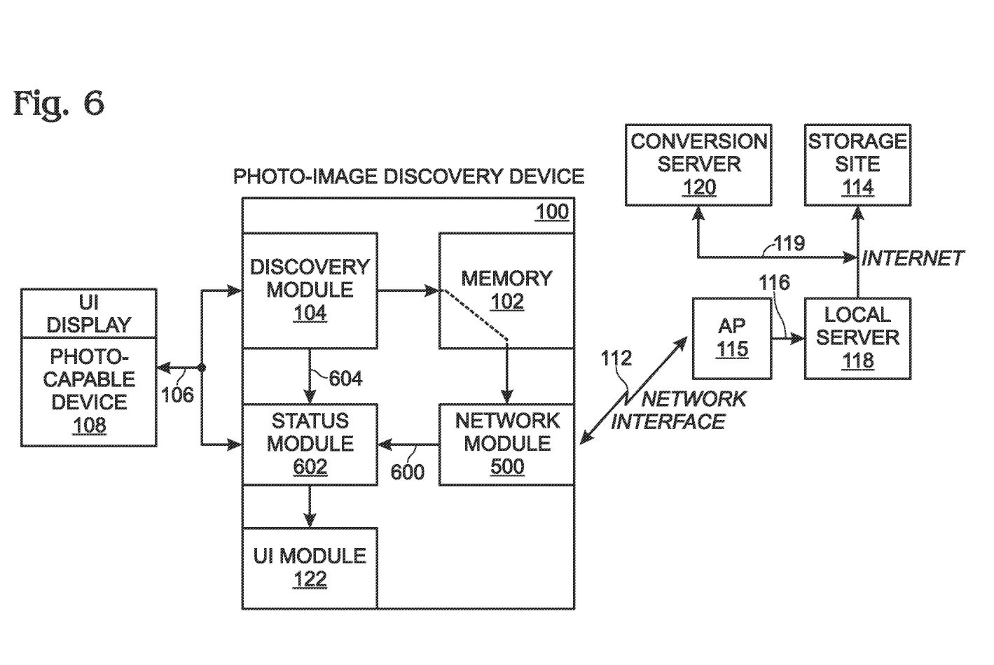

FIG. 6 is a schematic block diagram depicting a system for automatic photo-image uplink confirmation in a photo-image discovery device. The device 100 comprises a memory 102 and a discovery module 104 having a scanning interface 106 for detecting photo-capable devices 108. The discovery module 104 determines if detected photo-capable devices 108 have stored electronically formatted photo-images, and acquires the photo-images into the memory 102. A network module 500 has a network interface 112 for uploading the photo-images in the memory to a network-connected storage site 114, and a status interface on line 600 for supplying upload status information. A status module 602 has an interface on line 600 to receive the upload status information, and an interface on line 106 that is connected to the photo-capable device sourcing the photo-images, to automatically supply a log chronicling photo-image upload status. Alternately, the log is supplied to UI module 122, which may display the log via an LED display or speaker, for example.

If the log is sent to the photo-capable device, the status module 602 may supply the log in a photo-image file format for display on a user interface display of the photo-capable device. In one aspect, the status module 602 generates the log in a first file format (e.g., a text-based format) and converts the first file format to the photo-image format (e.g., JPEG). In another aspect, the status module 602 determines the photo-image file format of the acquired photo-images and converts the first file format to the determined photo-images. Thus, if the photo discovery device acquired GIF type photo-images from a camera 108, it would supply the log in the GIF format. The status module 602 may supply the log in one of the following photo-image file formats, which are commonly associated with image storage: JPEG, GIF, EXIF, native format, BMP, CR2, RAW, and MPEG. However, the log is not limited to just these examples. Neither is the log limited to only a photo-image file format. Other formats may include ASCII, TXT, PDF, and configuration files from game consoles.

The status module 602 generates a log chronicling upload status information such as upload complete (all the acquired photo-images were uploaded), no uplink connection, or uplink connection lost a first plurality of times (e.g., the photo discovery device attempted to find a WiFi uplink 5 times). The log can also record events such as photo-images rejected, file formats rejected (the photo-images are in the wrong format or the user does not have an account at the storage site), photo-image file format converted, image transformation operations, the file format types uploaded, the number of photo-images uploaded, authentication requirements (if any), and storage site unavailable. In one aspect, the status module 602 generates a log including a history of upload operations. Generally, the status module is able to log any type of activity that occurs (or doesn't occur) in the uplinking process, and the above list of examples is not intended to be exhaustive.

In another aspect, the discovery module 104 has an interface on line 604 to supply photo-image acquisition information. The status module 602 receives the photo-image acquisition information, and supplies an acquisition report to the photo-image capable device sourcing the photo-images on line 106, chronicling the photo-image acquisition status. The status module 602 supplies the acquisition report in a photo-image file format for display on the user interface display of the photo-capable device 108. For example, most cameras have an LCD display that can be used for this purpose. Again, the status module 602 may generate the acquisition report in a first file format, determine the photo-image file format of the acquired photo-images, and convert the first file format to the determined photo-images. Alternately, the acquisition report may be presented via the UI module 122 of the discovery device 100.

In one aspect, the storage site cooperates in the supply of uplink information. That is, the network module 500 may receive uplink confirmation information from the storage site and supply the uplink confirmation information in the upload status information. For example, the storage site may download information about the number of photo-images received or account management information. Then, the status module 602 generates a log including the uplink confirmation information.

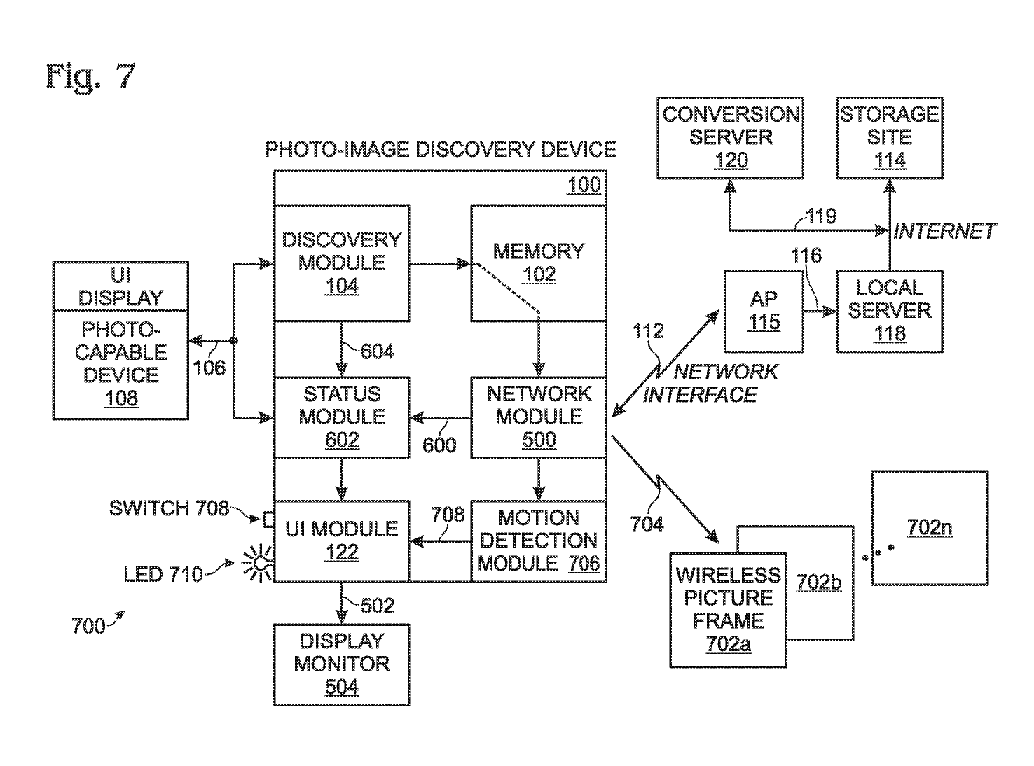

FIG. 7 is a schematic block diagram of a photo-image discovery device with a system for the local distribution of stored photo-images to wireless picture frames. The system 700 comprises a network module 500 for accessing photo-images from a network-connected storage site 114 and downloading selected photo-images. A M module 122 has an interface on line 502 connected to a non-dedicated display monitor 504 for presenting a menu of photo-image user prompt options. Generally, the interface can be HDMI, USB, infrared, Bluetooth, or WiFi, but the system is not limited to any particular type of hardwired or wireless connection.

The prompt options are used to select stored photo-images in response to the network module 500 accessing the storage site 114. The prompt options also select wireless picture frame destinations 702. Shown are wireless picture'frames 702a through 702n, where n is a variable not limited to any particular value. A wireless picture frame 702 is understood to be an electronic display dedicated to the display of a photo-image, or series of photo-images. The network module 500 wirelessly sends a selected photo-image to a selected wireless picture frame destination 700, as represented by reference designator 704. For example, the wireless interface represented by reference designator 704 may be Bluetooth or WiFi, but the system is not limited to any particular protocol.

In one aspect, the system 700 further comprises a motion detection module 706 for sensing photo-image discovery device motion, with an interface on line 708 connected to the UI module 122. In this aspect, the UI module 122 has an interface 504 to a wireless interface port of the display monitor 504 for presenting a menu of wireless picture frame destinations on the display monitor. Optionally, the motion detection feature can be enabled with a hardwire connection 502 to the display monitor 504. If the display monitor is not equipped for wireless communications, a wireless transceiver may be connected to a monitor input, and selected as the image source.

The wireless interface 504 is also used for selecting a wireless picture frame destination 700 in response to a detected motion. Note: in some aspects of the system, the. UI module 122 communicates with the display monitor using the same frequencies and protocols as the network interface 112 or the wireless picture frame interface 704. In this aspect, the UI module 122 and network module 500 may share transceiver hardware components.

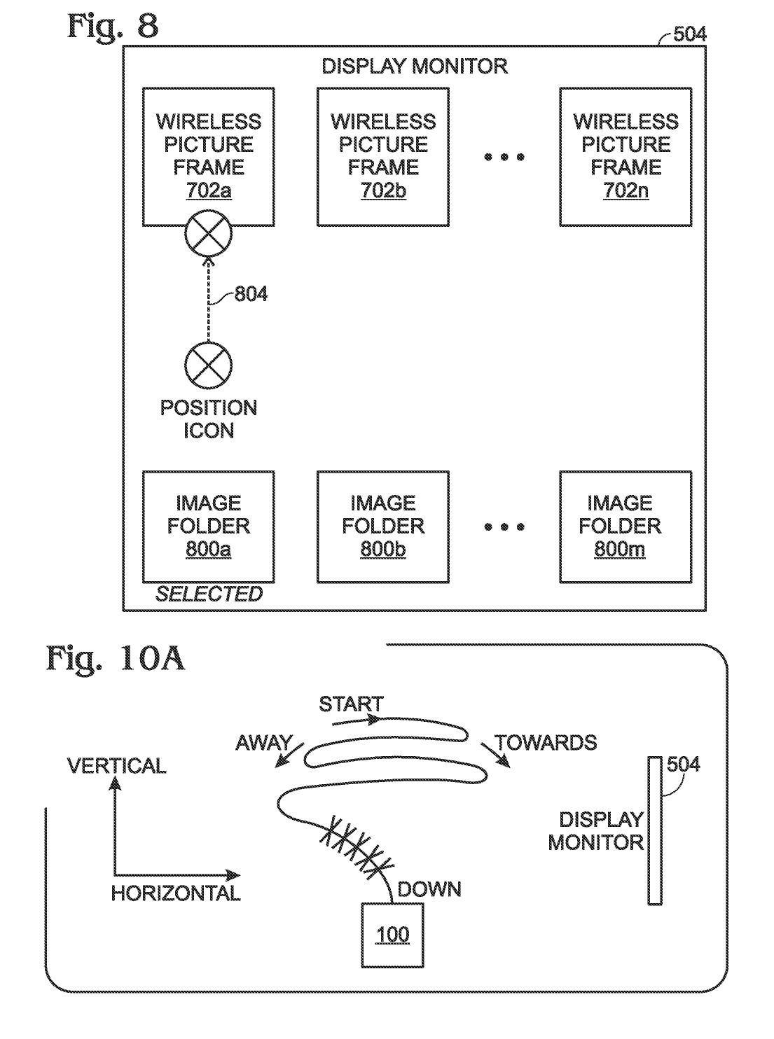

FIG. 8 is a diagram depicting an exemplary display menu for the selection of wireless picture frames 702. The UI module generates a position icon 802 on the display monitor 504 responsive to the movement of the photo-image discovery device, and uses photo-image discovery device movements to steer the position icon from the selected photo-image to the selected destination. As shown, image folders 800a through 800m have been downloaded, and folder 800a has been selected, see pending parent application entitled, SYSTEM AND METHOD FOR VIRTUAL KIOSK STORED PHOTO-IMAGE REPRODUCTION, invented by Vaysburg et al., Ser. No. 12/431,914, filed Apr. 29, 2009, attorney docket no. applied_{—}332.

The movement of the position icon 802 is represented by dotted line 804. In this example, the position icon is placed over an icon representing wireless picture frame 702a. The selection process may be completed, for example, by pressing a button associated with the UI module, or by another type of detectable motion. The cooperation between the photo-image discovery device and the monitor is similar in result to a Wii interface, except that the Wii system requires an infrared “eye” adjacent (e.g., on top of) the display, which is connected to the game console, for the purpose of tracking the movement of the handheld controller. The system described herein does not require a separate device to reference motion.

FIG. 9 is a diagram depicting a variation in the selection of wireless picture frames. The motion detection module establishes a directional reference axis 900 for pointing and detects the photo-image discovery device 100 being pointed at an actual location of a wireless picture frame (e.g., as shown, 702a) in a local physical environment surrounding the photo-image discovery device. The UI module selects the wireless picture frame destination in response to the detected pointing motion. The reference axis 900 need not necessarily be associated with an optical device. In some aspects, as explained in more detail below, the axis may be more relative than shown, and established as a result of a movement or change of device 100 position.

Returning to FIG. 7, in one aspect the system 700 further comprises a user interface switch 708 connected to the user interface module 122. In a manner similar to the selection of the wireless picture frame depicted in FIG. 8, the UI module 122 may select a photo-image by generating a position icon on the display monitor 504 responsive to the direction in which the photo-image discovery device is pointed, and using photo-image discovery device movements to steer the position icon to a photo-image (or folder of images) on the display monitor. The UI module 122 receives a selection prompt in response to the switch 708 being engaged. The motion detection module 706 detects the motion of pointing at the wireless picture frame in the physical environment, and the UI module 122 selects the wireless frame in response to the switch 708 being released.

In another aspect, the system 700 further comprises a user interface signaling device 710, such as a light emitting diode (LED) or a speaker. An LED is shown. The UI module 122 has an interface connected to the UI signaling device 710 for presenting feedback confirming the wireless picture frame selection. In other words, a signaling pattern created by the LED (or set of LEDs) can be used to indicate the successful completion of a selection act.

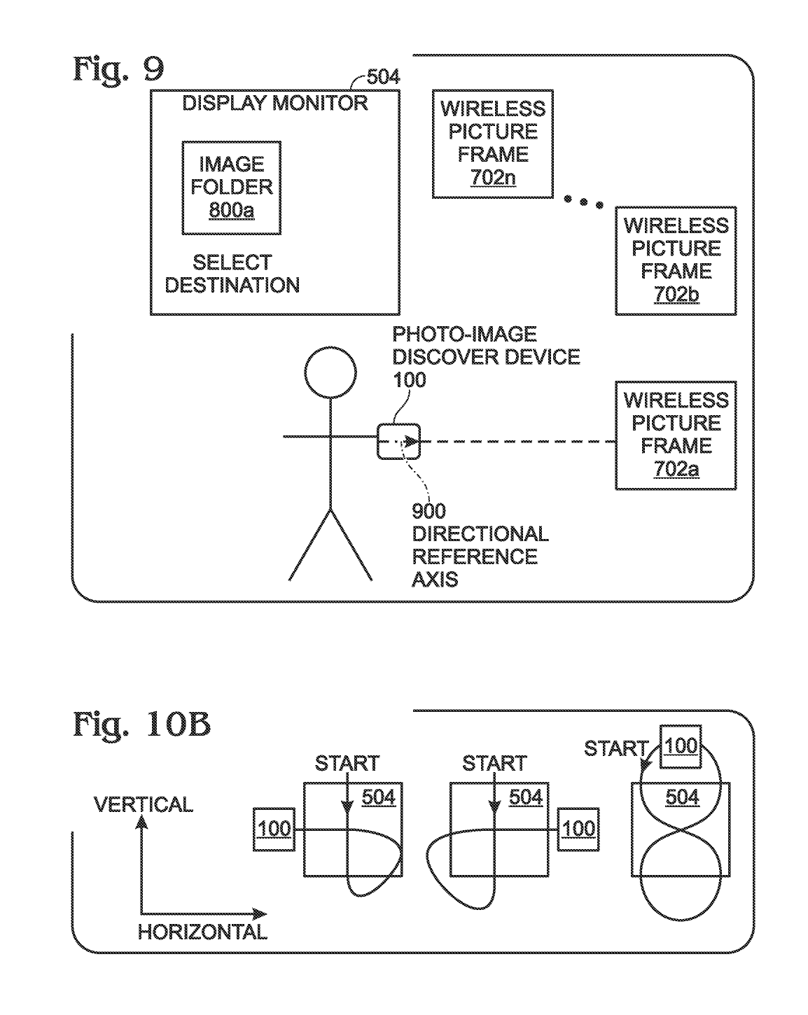

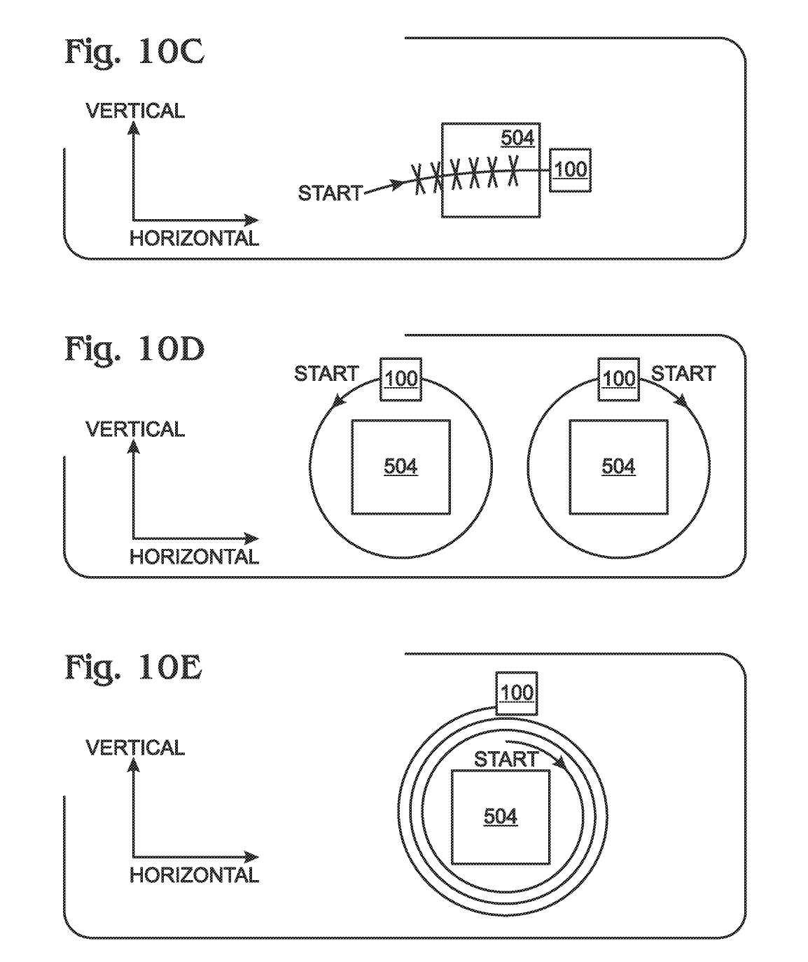

FIGS. 10A through 10E are diagrams depicting some exemplary motion prompts. The motion detection module detects one or more of the following motion prompts: point and select, on, off, select display, cancel selection, play, next, slow, previous, stop, next, start, and continuous. In FIG. 10A, the motion detection module interprets the “point and select” prompt in response to detecting a back-and-forth movement, towards and then away, followed by a rapid acceleration jerk in a vertical downward direction. The movement is depicted as a motion trail made be photo-image discovery device 100, where a cross-hatched line represents a rapid acceleration motion.

In FIG. 10B the motion detection module interprets the “stop” prompt in response to detecting a downward vertical movement crossed by a horizontal movement or figure-8 movement. In FIG. 10C the motion detection module interprets the “next” prompt in response to detecting a rapid acceleration jerk in a horizontal direction. The “next” prompt might be used for example, when flipping through photo-images or wireless picture frame options. In FIG. 10D the motion detection module interprets the “stop” prompt in response to detecting a circular movement. In FIG. 10E the motion detection module interprets the “continuous” prompt in response to detecting a plurality of circular movements. A “continuous” prompt might be used for example, to flip through options (without additional prompts), until a slow, fast, select, or stop command is received.

Although not specifically depicted, an “on” prompt might be signaled by shaking the photo-image discovery device several times. A “select” or “project” prompt may be signaled using a fishing pole casting motion. A “cancel” prompt may be signaled with an “X” motion. An “acknowledgement” (select is OK) prompt may be signaled with an “0” motion in the vertical plane. A “start” or “play” prompt may be signaled with an “0” motion in the horizontal plane. A “next” prompt may be signaled with a backwards wrist flick, such as in tugging a line. A “slow” prompt may be signaled with several wrist flicks. A progression from “stop” to “slow” to “forward” to “previous” may be signaled with wrist flicks to the right or left (from the perspective of a user facing the display monitor). The explicit command is dependent upon the previous command.

Motion detection prompts can also be used to select between different display monitors. A first display monitor can initially be designated as the “main” monitor, and a motion can be used to switch to a new monitor target.

Generally, the motion detection module detects a photo-image discovery device motion such as a change in position of the photo-image discovery device, a change in a direction in which the photo-image discovery device is pointing, or an acceleration of the photo-image discovery device. Motions may be detected through the use of an accelerometer, or a plurality of accelerometers, where each accelerometer is aligned in a different plane, and/or the use of tracking software. For example, three orthogonally aligned accelerometers might be used. In addition, motion can also be tracked through the use of a GPS receiver, and/or position triangulation. For example, position can be calculated using three WiFi transmitters.

In one aspect, the link between the network module 500 and the wireless picture frames is bi-directional. The UI module 122 selects a photo-image by generating a position icon on the display monitor responsive to the direction in which the photo-image discovery device is pointed, using photo-image discovery device movements to steer the position icon to a photo-image on the display monitor. The UI module receives a selection prompt in response to the switch 708 being engaged. Then, the network module 500 sends a selection signal to a plurality of wireless picture frames 700a-700n in the physical environment in response to the switch 708 being released. The network module 500 receives acknowledgement signals from each wireless picture frame 702a-702n reporting a signal strength of the received selection signal. The UI module 122 selects the wireless picture frame with the greatest reported signal strength.

In another aspect, subsequent to selecting a first wireless picture frame (e.g., 702a), the UI module 122 creates an icon on the display monitor 504 representing the first wireless picture frame (as in FIG. 8) and uses photo-image discovery device movements to steer the position icon from selected photo-images to the first wireless picture frame icon for subsequent selections.

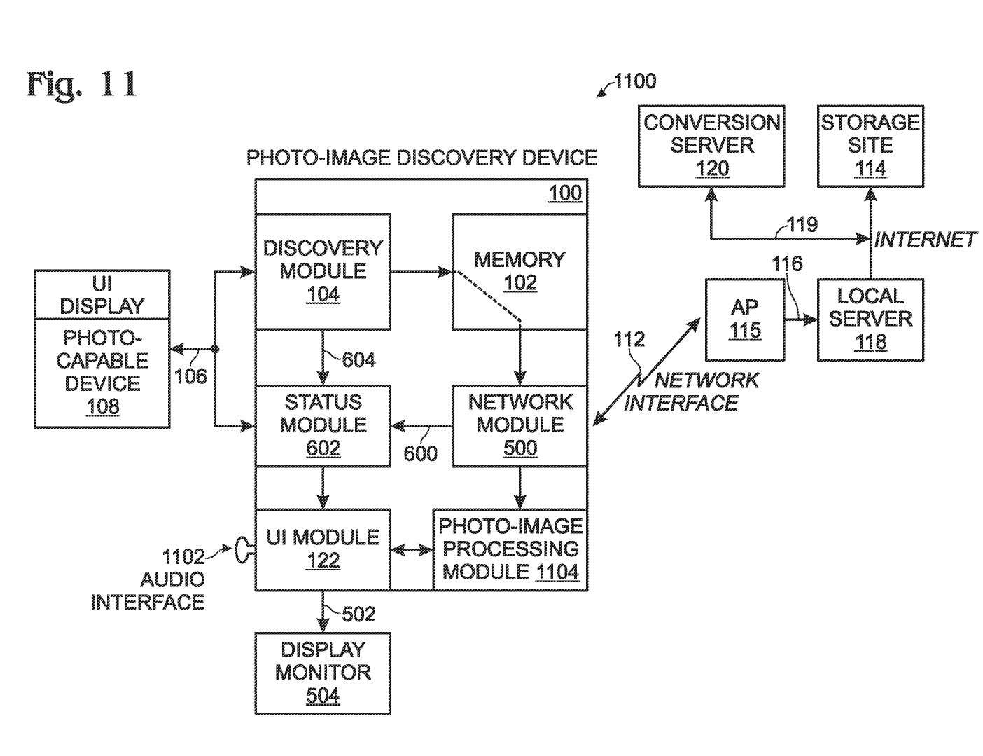

FIG. 11 is a schematic block diagram of a photo-image discovery device with a system for photo management using expression-based voice commands. Some details of the system 1100 have been presented above in the description of FIGS. 1-10E, and are not repeated here in the interest of brevity. The system 1100 comprises a user interface (UI) module 122 having an interface on line 502 connected to a non-dedicated display monitor 504. As explained in detail above, the interface 502 can be hardwired or wireless. The UI module 122 also has an audio interface 1102 (e.g., a microphone) to receive expression-based user voice prompts for accessing a photo-image in storage at a storage site 114. A network module 500 accesses photo-images from the network-connected storage site 114 and downloads selected photo-images in response to the expression-based voice prompts. The UI module 122 presents the accessed photo-image on the display monitor 504.

In one aspect, the UI module 122 presents a menu of user options on the display monitor 504, of operations such as selecting a storage site, selecting a photo-image, transforming a selected photo-image, converting a file format of a selected photo-image, or selecting a delivery option, to name a few examples. The UI module 122 receives expression-based user prompts in response to the menu of user options. Note: the menu options may also be selected using more conventional means, such as using button-selected icons, or as explained in the description of FIG. 7, using motion derived user prompts.

In one aspect, the system optionally comprises a photo-image processing module 1104 for performing operations such as transforming a photo-image or converting file formats. Photo-image transformation includes photo-image modifications such as resolution, size, cropping, zoom-in, zoom-out, hue, volume, contrast, and brightness, to name a few. Alternately, the system 1100 does not include a photo-image processing module, in which case the above-mentioned processes are not performed, or they are performed in a connected device. For example, the processes may be performed at the storage site 114.

Generally, the UI module 122 receives one of the following types of expression-based user voice prompts: a variable duration prompt, an expression-modified prompt, continuous-running prompt, or a volume-modified prompt. Additional details of the expression-based user voice prompts are provided below.

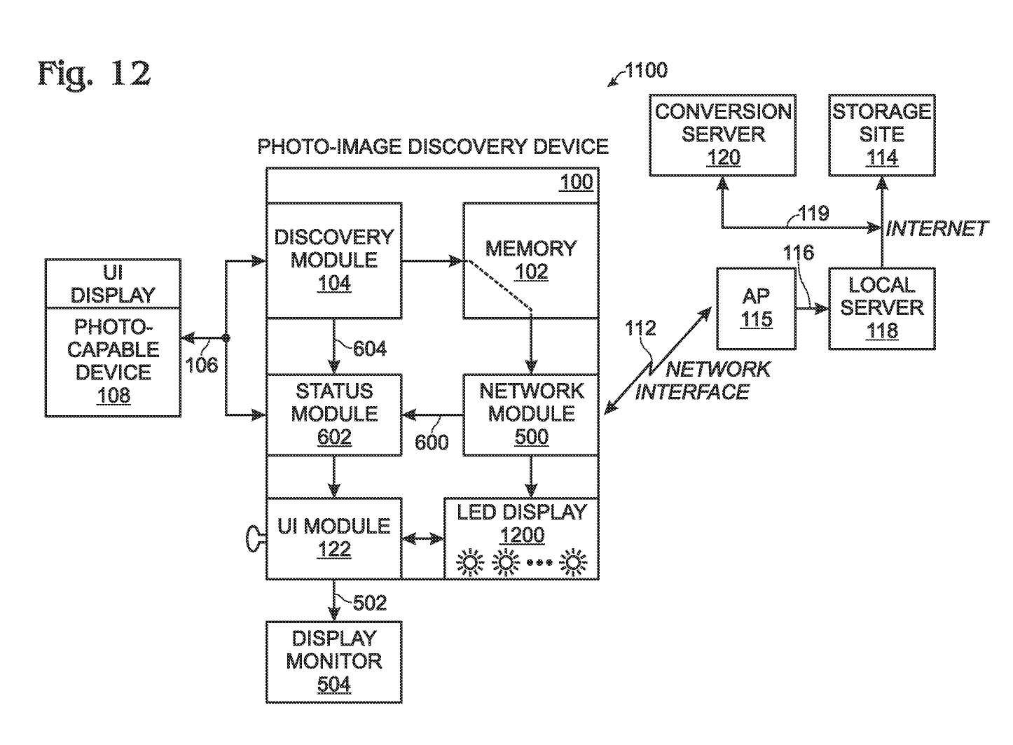

FIG. 12 is a photo-image discovery device with a system for presenting a light emitting device (LED) log. The device 100 comprises a memory 102, and a discovery module 104 having a scanning interface 106 for detecting photo-capable devices 108. The discovery module 104 determines if detected photo-capable devices have stored electronically formatted photo-images, and acquires the photo-images into the memory 102. A network module 500 has a network interface 112 for automatically uploading the photo-images in the memory 102 to a network-connected storage site 114. Typically, the network module 500 accesses photo-images from the network-connected storage site 114. The UI module 122 selects accessed photo-images (in response to user prompts and commands), and the network module 500 downloads the selected photo-images. Some details of the device 100 have been presented above in the description of FIGS. 1-11, and are not repeated here in the interest of brevity.

The device 100 also includes an LED display 1200 including LEDs 1202. A user interface (UI) module 122 is connected to the discovery module 104 and network module 500 to receive apparatus condition information. The UI module 122 is also connected to the LED display 1200 to present an LED log for communicating an apparatus condition to a user. The LED log emits light as a chronological sequence of LED patterns; e.g., a first LED pattern followed by (at least) a second LED pattern, where each pattern illuminates of at least one LED, and the first pattern is different from the second pattern.

The LED log can be used to communicate one or more of the following apparatus conditions: on, shutting down, battery level, photo-capable device discovered, uplink in progress, uplink problems, photo-image acquisition in progress, photo-image acquisition problems, photo-image acquisition complete, memory full, and apparatus conditions in a previous run. The term “previous run” refers to a status condition associated with an operation performed (or attempted) the previous time the photo-image discovery device was powered on. For example, upon powering-up the device, the LED log may indicate that photo-images acquired in a previous session were not successfully uplinked. Such a message would permit the user to complete or troubleshoot the uplink operation before performing another task.

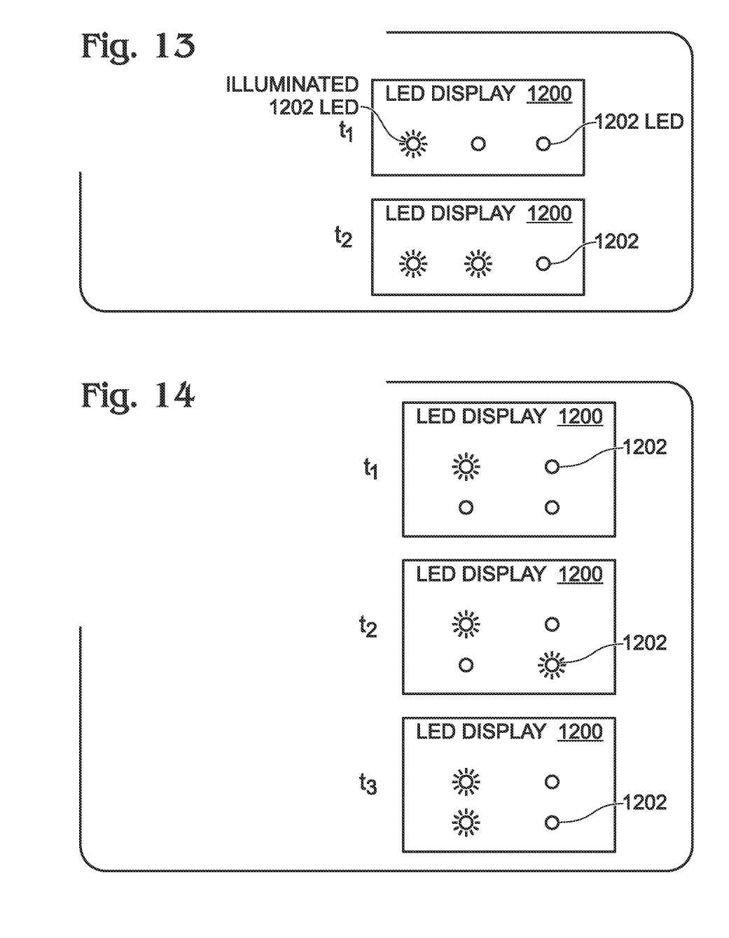

FIG. 13 is a detailed diagram of the LED display of FIG. 12, depicting a first example of an LED log. Shown is a first pattern (time=t1) with a first number (e.g., 1) of illuminated LEDs 1202 and a second pattern (t2) including a second number (e.g., 2) of illuminated LEDs 1202, different from the first number. Note: in this variation the location of an illuminated LED need not communicate any information. For example, the “on” condition may be signaled by the illumination of one LED (in any location) followed by the illumination of two LEDs (in any location). Also note that the minimum number of patterns in an LED log is two, and that more patterns may be used.

FIG. 14 depicts a second example of an LED log. In this aspect, the arrangement of LEDs is critical, and the particular LED 1202 illuminated in the arrangement conveys information. As shown, the. LED display 1200 is comprised of four LEDs 1202 mounted on the device in the fixed arrangement of a “box”. However, display is not limited to any particular number or arrangement of LEDs. The LED display presents the first pattern (t1) with a first number (e.g., 1) of LEDs illuminated in the arrangement and a second pattern (t2) with a second number (e.g., 2) of LEDs illuminated in the arrangement, where the second number is different from the first number. Note: the pattern shown at time=t3 conveys different information if it replaces the t2 pattern, even though the same number of LEDs are illuminated, since the arrangement of illuminated LEDs is different than the t2 pattern. That is, the sequence t1, t2 conveys different information than the sequence t1, t3. Also note that the minimum number of patterns in an LED log is two, and that more patterns may be used.

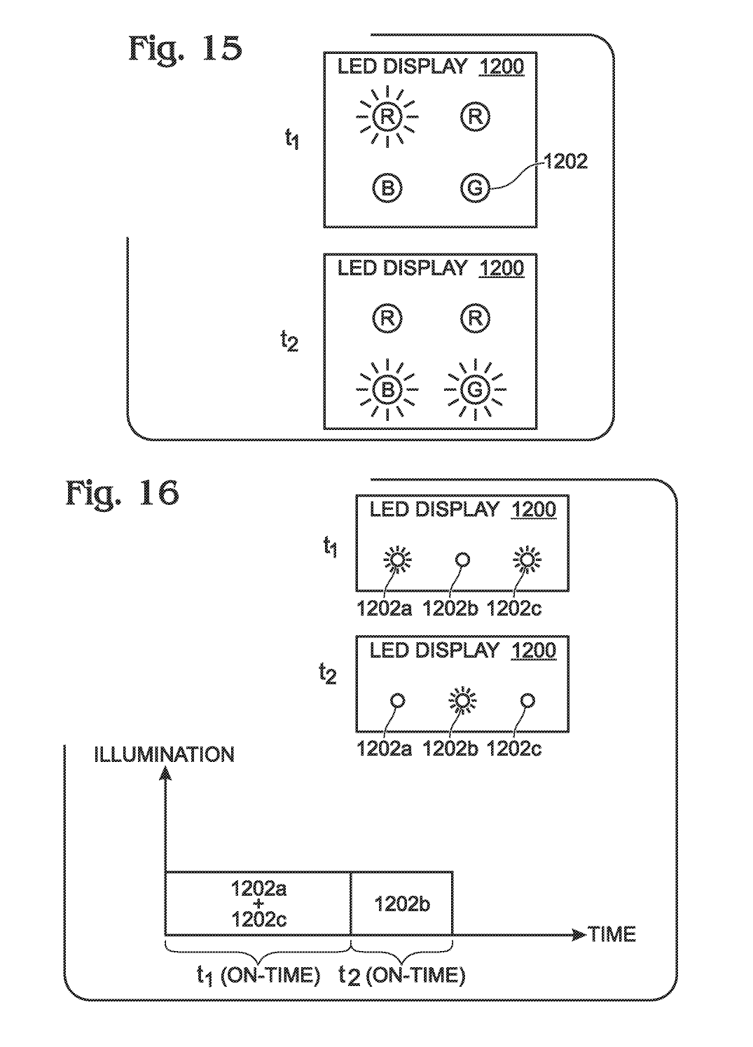

FIG. 15 depicts a third example of an LED log. In this aspect, the LED display 1200 includes. LEDs 1202 capable of emitting a plurality of light colors. In this aspect, the LED display 1200 presents the first pattern (t1) with a first combination of illuminated colors and the second pattern (t2) with a second combination of illuminated colors. Shown are the colors red (R), blue (B), and green (G). Note: that if multiple LEDs are used having the same color (e.g. 2 reds), then a pattern may be defined (or partially defined) simply by the illumination of a color (e.g., either red LED), or by the illumination of a particular LED (e.g., the left-most red LED). Again, the minimum number of patterns in an LED log is two, and more patterns may be used.

FIG. 16 depicts a fourth example of an LED log. In this aspect, the LED display 1202 presents a plurality of illuminated LEDs patterns and a plurality of pattern on-times. Two patterns and two different on-times are shown, but the LED log is not limited to either exemplary value. The patterns can be made more complex using color LEDs

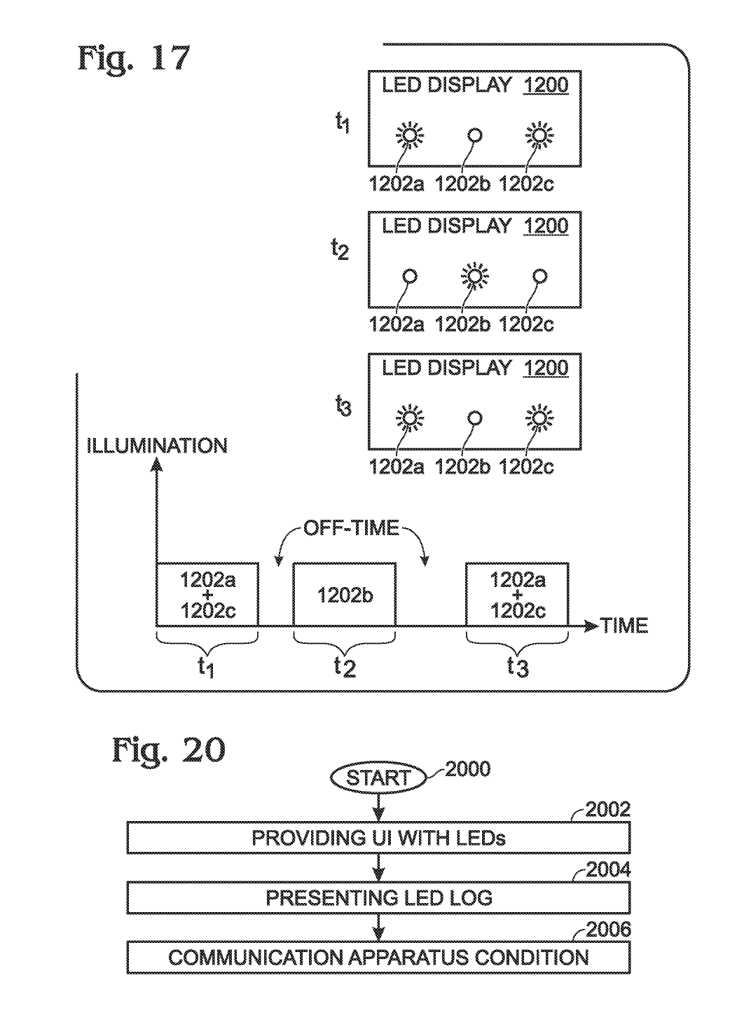

FIG. 17 depicts a fifth example of an LED log. In this aspect, the LED display 1200 presents a plurality of illuminated LEDs patterns and a plurality of pattern off-times. Three patterns and two different off-times are shown, but the LED log is not limited to either exemplary value. The patterns can be made more complex using color LEDs.

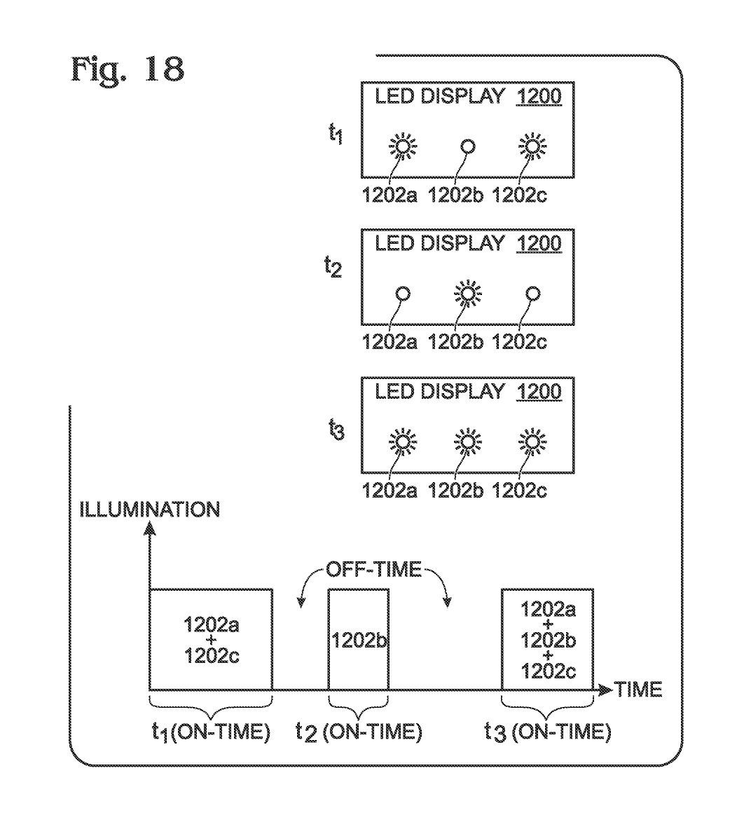

FIG. 18 depicts a sixth example of an LED log. In this aspect, the LED display 1200 presents a plurality of illuminated LEDs patterns, a plurality of pattern off-times, and a plurality of pattern on-times. Three patterns with three different on-times, and two different off-times are shown, but the LED log is not limited to any of these exemplary values. The patterns can be made more complex using color LEDs.

Although not specifically depicted, another means of creating LED patterns would be to control the brightness of particular LEDs and groups of LEDs.

The various components and modules of the photo discovery device may be enabled using state machine and combinational logic circuitry. Alternately, the device modules may be enabled using a software application of instructions that are stored in memory and executed by a processor. A photo discovery device processor with a configuration software application stored in memory is shown in FIG. 4A. Other applications in memory may include portions of the discovery, status, UI, motion detection, photo-image processing, and network modules.

### Functional Description

Conventionally, a user must perform many steps to store their pictures into a website for sharing, printing, or archiving. Further, a large proportion of these users either do not own a PC, or they are uncomfortable using a PC. These users would like to store, edit, print, and archive their pictures and video clips without having to go thru an intermediate step requiring the use of a PC.

To that end, the photo-image discovery device described in FIG. 1 automates the upload of files from devices such as a digital camera, 3G phones, and cell phone to a backend service by reducing/eliminating the user intervention. Reduced user intervention accelerates the availability of photo-images for sharing, viewing, protecting, and printing. Unlike conventional automatic acquisition technology, the photo-image discovery device disclosed herein is not limited to a single kind of image media, single image source, or single image destination.

The system described in FIG. 5 permits any monitor, including a TV screen, PC monitor, or digital picture frame to become a virtual kiosk for organizing pictures in a repository website or back end photo service center. The kiosk can be used to order prints and arrange delivery of those prints. The kiosk provides a home shopping experience without the bother of using a PC.

FIG. 19 is a diagram depicting the photo-image discovery device from a functional perspective. In one aspect, a digital camera or SD memory card is connected to the photo-image discovery device using a USB cable. The photo-image discovery device automatically transfers pictures, video clips, files to its memory/storage and asynchronously starts to upload those files, thru WiFi, to an archive backend service or picture website.

From a cell phone, a Bluetooth connection may be established (pairing), and images acquired from the cell phone through the Bluetooth connection are uploaded to the backend service or the picture website. From a 3G phone, a WiFi connection is established with the photo-image discovery device and WiFi link is used to acquire pictures and video clips. A second WiFi link is used to transfer images from the photo-image discovery device to the backend service or picture website.

FIG. 20 is a flowchart illustrating a method for presenting an apparatus history using an LED log. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 2000.

Step 2002 provides an apparatus user interface (UI) including a plurality of LEDs. Step 2004 presents an LED log. The LED log emits light as a chronological sequence patterns. For example, a first LED pattern may be followed by a second LED pattern, where each pattern includes the illumination of at least one LED. The first pattern is different from the second pattern. In response to the LED log, Step 2006 communicates an apparatus condition.

In one aspect, Step 2002 provides a photo-image discovery device UI, and Step 2006 communicates at least one of the following conditions: on, shutting down, battery level, photo-capable device discovered, uplink in progress, uplink problems, photo-image acquisition in progress, photo-image acquisition problems, photo-image acquisition complete, memory full, or an apparatus conditions in a previous run.

In another aspect, Step 2004 presents a first pattern with a first number of illuminated LEDs and a second pattern including a second number of illuminated LEDs, different from the first number, see FIG. 13. In one aspect, Step 2002 provides LEDs mounted on the apparatus in a fixed arrangement. Then, Step 2004 presents a first pattern with a first number of LEDs illuminated in the arrangement and a second pattern with a second number of LEDs illuminated in the arrangement, where the second number is different from the first number, see FIG. 14.

In another aspect, Step 2002 provides LEDs capable of emitting a plurality of light colors. Then, Step 2004 presents a first pattern with a first combination of illuminated colors and a second pattern with a second combination of illuminated colors, see FIG. 15. In one aspect, Step 2004 presents a plurality of illuminated LEDs patterns and a plurality of pattern on-times, see FIG. 16. In a different aspect, Step 2004 presents a plurality of illuminated LEDs patterns and a plurality of pattern off-times, see FIG. 17. In one aspect, Step 2004 presents a plurality of illuminated LEDs patterns, a plurality of pattern off-times, and a plurality of pattern on-times, see FIG. 18.

A system and method have been provided for presenting an apparatus history using an LED log. Examples of specific patterns, processes, and hardware modules have been given to illustrate the invention. However, the invention is not limited to merely these examples. Other variations and embodiments of the invention will occur to those skilled in the art.

We claim:

1. A method for presenting an apparatus history using a light emitting device (LED) log, the method comprising:
providing an apparatus user interface (UI) including a plurality of LEDs;
presenting an LED log, the LED log emitting light as a chronological sequence of a first LED pattern followed by a second LED pattern, where each pattern includes the illumination of at least one LED, and the first pattern is different from the second pattern; and,
in response to the LED log, communicating an apparatus condition.

2. The method of claim 1 wherein presenting the first and second patterns includes a presenting a first pattern with a first number of illuminated LEDs and a second pattern including a second number of illuminated LEDs, different from the first number.

3. The method of claim 1 wherein providing the apparatus UI with the plurality of LEDs includes providing LEDs mounted on the apparatus in a fixed arrangement; and,
wherein presenting the first and second patterns includes a presenting a first pattern with a first number of LEDs illuminated in the arrangement and a second pattern with a second number of LEDs illuminated in the arrangement, where the second number is different from the first number.

4. The method of claim 1 wherein providing the apparatus UI with plurality of LEDs includes providing LEDs capable of emitting a plurality of light colors; and,
wherein presenting the first and second patterns includes a presenting a first pattern with a first combination of illuminated colors and a second pattern with a second combination of illuminated colors.

5. The method of claim 1 wherein presenting the LED log includes presenting a plurality of illuminated LEDs patterns and a plurality of pattern on-times.

6. The method of claim 1 wherein presenting the LED log includes presenting a plurality of illuminated LEDs patterns and a plurality of pattern off-times.

7. The method of claim 1 wherein presenting the LED log includes presenting a plurality of illuminated LEDs patterns, a plurality of pattern off-times, and a plurality of pattern on-times.

8. The method of claim 1 wherein providing the apparatus UI includes providing a photo-image discovery device UI.

9. The method of claim 8 wherein communicating the apparatus condition in response to the LED log includes communicating a condition selected from a group consisting of on, shutting down, battery level, photo-capable device discovered, uplink in progress, uplink problems, photo-image acquisition in progress, photo-image acquisition problems, photo-image acquisition complete, memory full, and apparatus conditions in a previous run.

10. A photo-image discovery device with a system for presenting a light emitting device (LED) log, the device comprising:
a memory;
a discovery module having a scanning interface for detecting photo-capable devices, the discovery module determining if detected photo-capable devices have stored electronically formatted photo-images, and acquiring the photo-images into the memory;
a network module having a network interface, the network module automatically uploading the photo-images in the memory to a network-connected storage site;
an LED display;
a user interface (UI) module connected to the discovery and network modules to receive apparatus condition information, and connected to the LED display to present an LED log for communicating an apparatus condition to a user, the LED log emitting light as a chronological sequence including a first LED pattern followed by a second LED pattern, where each pattern illuminates of at least one LED, and the first pattern is different from the second pattern.

11. The device of claim 10 wherein the network module accessing photo-images from the network-connected storage site;
wherein the UI module selects accessed photo-images; and,
wherein the network module downloads the selected photo-images.

12. The device of claim 11 wherein the LED log communicates an apparatus condition selected from a group consisting of on, shutting down, battery level, photo-capable device discovered, uplink in progress, uplink problems, photo-image acquisition in progress, photo image acquisition problems, photo-image acquisition complete, memory full, and apparatus conditions in a previous run.

13. The device of claim 10 wherein the LED display presents an LED log including the first pattern with a first number of illuminated LEDs and a second pattern including a second number of illuminated LEDs, different from the first number.

14. The device of claim 13 wherein the LED display is comprised of LEDs mounted on the device in a fixed arrangement, and wherein the LED display presents the first pattern with a first number of LEDs illuminated in the arrangement and a second pattern with a second number of LEDs illuminated in the arrangement, where the second number is different from the first number.

15. The device of claim 10 wherein the LED display includes LEDs capable of emitting a plurality of light colors, and wherein the LED display presents the first pattern with a first combination of illuminated colors and the second pattern with a second combination of illuminated colors.

16. The device of claim 10 wherein the LED display presents a plurality of illuminated LEDs patterns and a plurality of pattern on-times.

17. The device of claim 10 wherein the LED display presents a plurality of illuminated LEDs patterns and a plurality of pattern off-times.

18. The device of claim 10 wherein the LED display presents a plurality of illuminated LEDs patterns, a plurality of pattern off-times, and a plurality of pattern on-times.
